(19) United States
(12) Patent Application Publication
(10) Pub. No.: US 2018/0211312 A1
(43) Pub. Date: Jul. 26, 2018

(54) Systems and Methods for Intraday Facility Monitoring

(71) Applicant: JPMorgan Chase Bank, N.A., New York, NY (US)

(72) Inventors: Jason Smith, London (GB); Agim Perolli, Carmel, NY (US); Ulku Rowe, New York, NY (US); Tim Stoddart, Surrey (GB); Satyajit Balkrishna Saste, Hillsboro, OR (US)

(21) Appl. No.: 15/414,775

(22) Filed: Jan. 25, 2017

(51) Int. Cl. G06Q 40/02; G06Q 20/40

(52) U.S. Cl. CPC G06Q 40/025; G06Q 2220/00; G06Q 20/40

(57) ABSTRACT

Systems and methods for intraday facility monitoring are disclosed. In one embodiment, a method for real-time management of risk exposure for an organization may include (1) a server comprising at least one computer processor ingesting a plurality of messages from a plurality of source systems, each message relating to credit extended by an organization to one of a plurality of clients of the organization; (2) the server enriching each of the plurality of messages with reference data; (3) the server persisting the plurality of message in a database; (4) the server determining a credit risk exposure based on the persisted messages; (5) the server comparing the credit risk exposure to a risk threshold; and (6) the server reporting the credit risk exposure.

### BACKGROUND OF THE INVENTION

### 1. Field of the Invention

The present disclosure generally relates to systems and methods for intraday facility monitoring.

### 2. Description of the Related Art

In the wake of the 2008 financial crisis, the ability for systemically important financial institutions to make credit risk decisions in real-time based on current data aggregated across businesses and systems around the globe is critical for the stability of the global economy. The ability for a financial institution to make credit risk decisions based on current aggregate cross business/system is critical for the institution.

### SUMMARY OF THE INVENTION

Systems and methods for intraday facility monitoring are disclosed. In one embodiment, a method for real-time management of risk exposure for an organization may include (1) a server comprising at least one computer processor ingesting a plurality of messages from a plurality of source systems, each message relating to credit extended by an organization to one of a plurality of clients of the organization; (2) the server enriching each of the plurality of messages with reference data; (3) the server persisting the plurality of message in a database; (4) the server determining a credit risk exposure based on the persisted messages; (5) the server comparing the credit risk exposure to a risk threshold; and (6) the server reporting the credit risk exposure.

In one embodiment, the message may be related to a transaction, such as a security transaction, a settlement transaction, a cash movement transaction, etc.

In one embodiment, the plurality of source system may include a Clearing Credit Checking system, an Automated Clearing House system, an Account Monitoring and Payment Authorization system, etc.

In one embodiment, the reference data may include a domicile for the client, the client name, a client identifier, parent information for the client, etc.

In one embodiment, the method may further include the server encrypting the plurality of messages that are enriched with reference data before persisting the messages in the database.

In one embodiment, the method may further include the server aggregating the persisted messages with an updated message. The credit risk exposure may be based on the aggregated messages.

In one embodiment, the credit risk threshold may be based on a risk exposure policy.

In one embodiment, the method may further include the server executing a hold on an amount of funds in response to the credit risk exposure exceeding the credit risk threshold.

In one embodiment, the method may further include the server executing a hold on an account associated with the client.

According to another embodiment a system for real-time management of risk exposure for an organization may include a server comprising at least one computer processor and an interface with a plurality of source systems; at least one database; and a dashboard. In one embodiment, the server may: ingest a plurality of messages received at the interface from the plurality of source systems, each message relating to credit extended by an organization to one of a plurality of clients of the organization; enrich each of the plurality of messages with reference data; persist the plurality of message in the at least one database; determine a credit risk exposure based on the persisted messages; compare the credit risk exposure to a risk threshold; and report the credit risk exposure to the dashboard.

In one embodiment, the message may be related to a transaction, such as a security transaction, a settlement transaction, a cash movement transaction, etc.

In one embodiment, the plurality of source system may include a Clearing Credit Checking system, an Automated Clearing House system, an Account Monitoring and Payment Authorization system, etc.

In one embodiment, the reference data may include a domicile for the client, the client name, a client identifier, parent information for the client, etc.

In one embodiment, the server may encrypt the plurality of messages that are enriched with reference data before persisting the messages in the database.

In one embodiment, the server may aggregate the persisted messages with an updated message. The credit risk exposure may be based on the aggregated messages.

In one embodiment, the credit risk threshold may be based on a risk exposure policy.

In one embodiment, the server may execute a hold on an amount of funds in response to the credit risk exposure exceeding the credit risk threshold, may execute a hold on an account associated with the client, etc.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for intraday facility monitoring according to one embodiment; and

FIG. 2 depicts a method for intraday facility monitoring according to one embodiment.

### DETAILED DESCRIPTION OF PREFERRED EMBODIMENTS

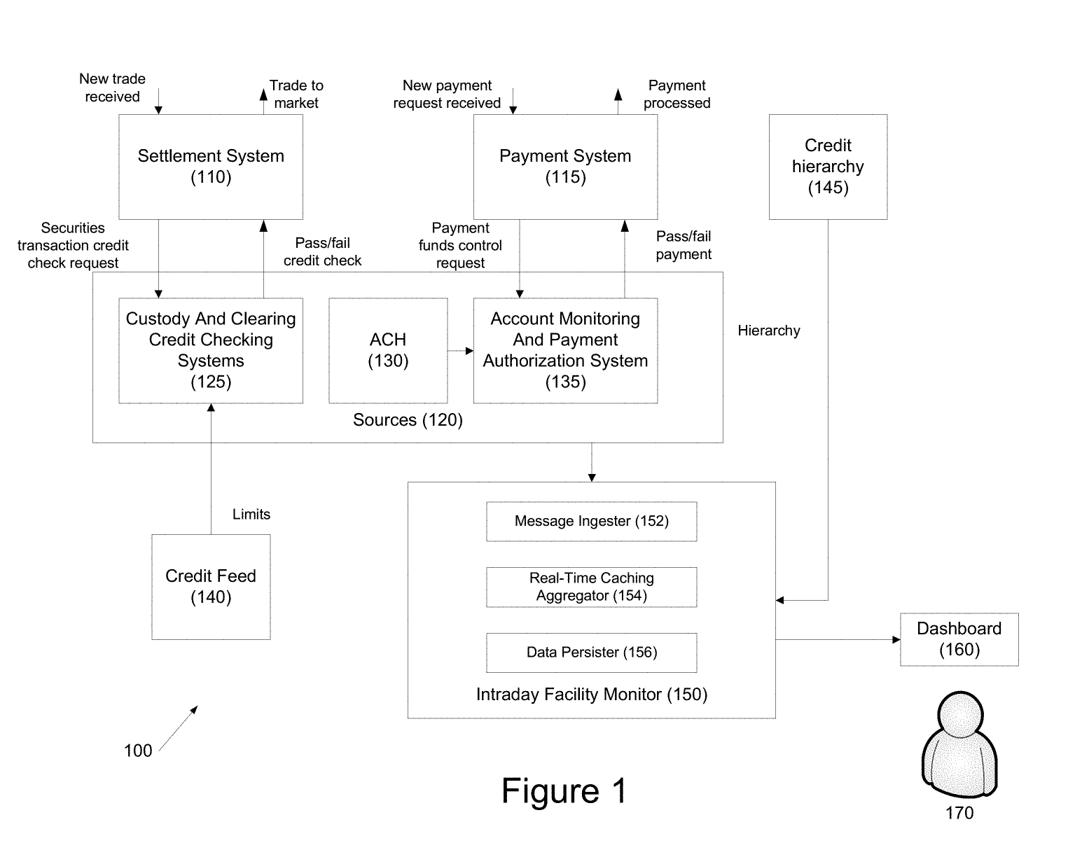

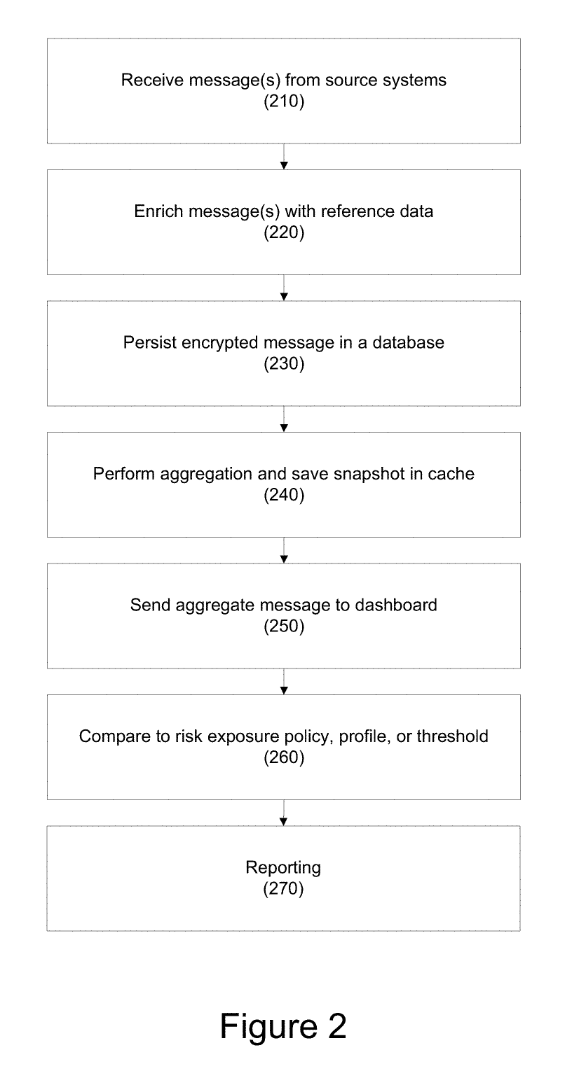

Several embodiments of the present invention and their advantages may be understood by referring to FIGS. 1-2.

Embodiments are directed to system and method for intraday facility monitoring for an organization, such as a financial institution.

Financial institutions typically advance credit for the settlement for transactions involving their clients, such as securities settlement and cash movements. Multiple separate systems across many divisions, lines of business, affiliates, subsidiaries, etc. of the financial institution may process millions of transactions daily, with each requiring evaluation against predefined credit limits. Financial institutions are generally required to make quick, accurate, and informed decisions when the activity of one of its client's results in a breach of the client's intraday credit limit.

The approval process typically requires significant manual review of across multiple systems to assess the client exposure across multiple financial products offered by the financial institution as well as lines of business within the financial institution. This manual process, however, has high latency between the time the credit operations users collects the system specific credit usage data and the point at which a credit breach approval decision is made.

Substantial manual work is often required to source the data from individual systems and create high level view of intraday credit utilization for real-time monitoring of client intraday credit usage, analytics of intraday usage patterns in order to optimally size, price and manage the credit limits, and for submissions to regulators and for required client reports.

According to embodiments, systems and methods for intraday facility monitoring may use credit usage balance and supporting data that may be provided by credit limit checking systems in order to address these and other issues.

In one embodiment, the high volume of intraday credit utilization data may be continuously gathered centrally and may be enriched with supporting credit and/or client reference data. For example, data may be enriched with a Universal Client Number Description, a Credit Family Name, a Ultimate Parent UCN, etc. This enriched data may be stored at a highly granular level using, for example, big data technology such as Hadoop in a “Credit Risk Historic Intraday Credit Utilization Data Store.” The data store may provide a foundation for detailed analytics, pattern discovery and multi-dimensional reporting of client intraday credit usage.

In one embodiment, the enrichment process may comprise associating the message(s) with supporting credit and/or reference data, embedding the message with supporting credit and/or reference data, etc.

In one embodiment, the intraday credit usage updates may be aggregated in real-time across various dimensions, and may be supplied to, for example, a downstream internal intranet dashboard for presentation in real-time, for example, credit risk officers, senior management, etc.

In one embodiment, machine learning and/or predictive analysis may be used with the contents of the data store to, for example, identify patterns in client credit utilization in response to the prevailing financial market conditions.

In one embodiment, extended analytics and reporting capability over the contents of the data store, along with interactive user screens for the presentation of intraday balance updates, may be provided.

In one embodiment, a centralized operational workflow of intraday credit limit breached management may be provided.

In one embodiment, feedback into the automated limits setting systems for refined daily control of client credit limits may be used.

In one embodiment, centralized real-time credit limit checking control to augment or replace existing “siloed” limit checking systems may be used.

Referring to FIGS. 1 and 2, a system for intraday facility monitoring is disclosed according to one embodiment. System 100 may include settlement system 110, payment system 115, sources 120 which may include one or more of Custody and Clearing Credit Checking Systems 125, Automated Clearing House (ACH) 130, Account Monitoring and Payment Authorization System 135, credit feed 140, credit hierarchy 145, intraday facility monitor 150, dashboard 160.

In one embodiment, intraday facility monitory 150 may monitor credit exposure for an organization, such as a financial institution. In another embodiment, intraday facility monitory 150 may monitor credit exposure for clients of the organization.

In one embodiment, settlement system 110 may execute trades. For example, settlement system 110 may receive a client instruction to settle a securities transaction in the market. An example is a client requests a financial institution to release a quantity of 100 stocks to the market to fulfill a sale transaction they have struck with their market counterparty.

In one embodiment, settlement system 110 may interface with Custody and Clearing Credit Checking Systems 125. For example, when a new trade is received, settlement system 110 may request a securities transaction credit check via Custody and Clearing Credit Checking Systems 125. Custody and Clearing Credit Checking Systems 125 may return the results of the credit check to settlement system 110. In one embodiment, a new trade may be received as an instruction directly from a client, or may be manually entered into settlement system 110.

Payment system 115 may process one or more incoming or outgoing payments for clients of the organization. For example, payment system 115 may receive a client instruction to settle a cash transaction. An example of this is a client requesting a financial institution to action a payment request to a counterparty. In one embodiment, payment system 115 may interface with Account Monitoring and Payment Authorization System 135. For example, when a new payment request is received directly from a client, payment system 115 may submit a payment funds control request to Account Monitoring and Payment Authorization System 135 to release a cash payment to the market. This may involve systemically verifying that there is sufficient positive cash balance or overdraft associated with the account to which the funding request relates. In response to the request, Account Monitoring and Payment Authorization System 135 may return the results to payment system 115, which may then process the payment.

As discussed above, Custody and Clearing Credit Checking Systems 125 may interface with settlement system 110. In one embodiment, Custody and Clearing Credit Checking Systems 125 may calculate and maintain an accurate securities collateral balance for the client. A proportion of this balance may be used to offset credit risk exposure of the client's securities trading.

In addition, Custody and Clearing Credit Checking Systems 125 may provide intraday real-time breached transaction and collateral valuation reporting on screen; end of day summary reporting to Credit Risk reporting systems; the ability for the manual operational approval of transactions in breach of the predefined credit limit.

ACH 130 may interface with Account Monitoring and Payment Authorization System 135 and may perform bulk payments.

Account Monitoring and Payment Authorization System 135 may interface with payment system 115 and may provide reporting, such as manual breached cash transaction approval, intraday, and end of day reporting.

Custody and Clearing Credit Checking Systems 125 may further perform credit limit checking of securities settlement transactions. In one embodiment, Custody and Clearing Credit Checking Systems 125 may receive a data feed from credit feed 140. This data feed may include credit data for the individual or entity.

Intraday facility manager 150 may interface with Custody and Clearing Credit Checking Systems 125, ACH 130, and Account Monitoring and Payment Authorization System 135. In one embodiment, data from one or more of Custody and Clearing Credit Checking Systems 125, ACH 130, and Account Monitoring and Payment Authorization System 135 may be pushed to intraday facility manager 150; in another embodiment, data from one or more of Custody and Clearing Credit Checking Systems 125, ACH 130, and Account Monitoring and Payment Authorization System 135 may be pulled by intraday facility manager 150.

In one embodiment, data from one or more of Custody and Clearing Credit Checking Systems 125, ACH 130, and Account Monitoring and Payment Authorization System 135 may be ingested by message ingester 152. For example, messages from one or more of sources 120 may be received by intraday facility monitor 150 in, for example, JSON format and may be transported using, for example, MQ messaging. Message ingester 152 may be a Java-based processes that reads each of the data element in the message and stores the data in a cache (not shown).

Real-time caching aggregator 154 may cache and aggregate the data, and data persister 156 may persist the data. In one embodiment, real-time caching aggregator may use, for example, Java processes to calculate various predefined aggregations of the intraday credit utilization data processed by message ingester 152. In one embodiment, supporting reference data may be sourced from a reference data repository (RDR) application (not shown).

In one embodiment, the resulting credit usage data aggregations may be formatted using, for example, a predefined JSON message structure and may be transported by MQ transport downstream to dashboard 160.

In one embodiment, data persister 156 may take each credit usage data update with supporting reference data from the cache (not shown) and may write each update to, for example, a historic data store, such as Cloudera hbase (not shown).

Intraday facility manager 150 may execute on one or more servers (not shown) and may interface with user 170 using dashboard 160. It may further receive a credit hierarchy from credit hierarchy 145. In one embodiment, dashboard 160 may present results of Intraday Credit Usage aggregations in a suitable format (e.g., graphical and/or tabular). It may further provide visualization of the data produced and provided by Intraday Facility Manager 150.

Referring to FIG. 2, a method for intraday facility monitoring is disclosed according to one embodiment.

In step 210, one or more message may be received from one or more source system, including, for example, Clearing Credit Checking Systems, ACH Systems, and Account Monitoring and Payment Authorization Systems. In one embodiment, the messages may be received in real-time, or substantially in real-time.

In one embodiment, each message may be related to credit extended by an organization to one of a plurality of clients of the organization. Examples may include incoming or outgoing payments for clients of the organization, securities settlements, cash movements, etc.

In step 220, the message(s) may be enriched with reference data. For example, the messages may be enriched with country of domicile, industry, etc., for the associated client. Other examples of reference data that may be used are provided in the table, below:

| Data Field | Definition |
|---|---|
| Client OID | Operational ID (internal id used in RDR) |
| | for the client UCN as recorded in RDR |
| Universal Client Number | UCN of the client as recorded in RDR |
| (UCN) | |
| Client Account Security | CASID for the client UCN as recorded in RDR |
| ID (CASID) | |
| Enterprise Client ID | ECID for the client UCN as recorded in RDR |
| (ECID) | |
| Client Name | Name for the client UCN as recorded in RDR |
| NAIC Code | The North American Industry Code assigned |
| | to the client UCN |
| NAIC Secondary | The secondary description of this NAIC code. |
| Description | (The division in which this NAIC code exists). |
| Client Sub Type | Sub-Type for the client UCN. Values are: |
| | ‘BULK’, ‘IND’, ‘NON-IND’, ‘INT’, (value |
| | INT = Internal). |
| Credit Family Name | The name of the credit family for the ultimate |
| | parent of the client. |
| Fund Family Name | The name of the fund family containing the |
| | client UCN. |
| Informational Family | The name of the Informational family contain- |
| Name | ing the client UCN. |
| Ultimate Parent OID | Operational ID (internal id used in RDR) for |
| | the ultimate parent UCN |
| Ultimate Parent UCN | The UCN of the ultimate parent of the client |
| | UCN |
| Ultimate Parent Name | The name of the ultimate parent of the client |
| | UCN |
| Ultimate Parent CASID | CASID for the ultimate parent UCN |
| Ultimate Parent ECID | ECID for the ultimate parent UCN |
| NAIC Group | NAIC Group for the Client UCN |
| Client Obligor Code | Obligor code for the Client UCN |
| Ultimate Parent Obligor | Obligor code for the Ultimate Parent UCN |
| Code | |
| Client CRU | The Credit Responsibility Unit associated with |
| | the Client |

In step 230, the message(s) may be encrypted and persisted in a database. In one embodiment, the database may be a distributed, scalable, big data store, such as Apache Hbase. Other databases may be used as is necessary and/or desired.

In step 240, the data may be aggregated and a snapshot may be stored in a cache. For example, as an update for an entity is received, it may be aggregated with persisted data in order to reflect current credit exposure for a group of accounts that may be defined by the underlying credit checking system (e.g., for the same client), exposure for the organization, etc. In one embodiment, the data may be aggregated for subsidiaries, affiliates, etc. of the entity or organization as necessary and/or desired.

In one embodiment, the aggregation may be done substantially in real-time.

In step 250, a message comprising the aggregated data may be sent to a dashboard or other user interface. For example, the aggregated data may be presented to credit risk officers, senior management, etc. for the organization.

In one embodiment, the data may be sent to the dashboard immediately upon aggregation.

In step 260, the aggregated data may be compared to a risk exposure policy, threshold, etc. that may be defined by the organization. The exposure policy may establish thresholds, limits, etc. for the organization, for individual clients, etc.

In one embodiment, one or more automated actions may be taken if the aggregated data shows an unacceptable risk exposure, such as putting a hold on account(s), etc. For example, alerts may be set on the dashboard to warn of a breach, etc.

In one embodiment, additional funds may be put on reserve in responses to an unacceptable risk exposure for the organization.

In step 270, reporting may be performed. In one embodiment, reports on the dimensions of Intraday Credit Utilization, Aggregation by Credit Family, Aggregation by Industry, 5-Day forward looking exposure; Credit Usage versus Credit Limit, and any other suitable report as is necessary and/or desired.

Although several embodiments have been disclosed, it should be recognized that these embodiments are not exclusive to each other.

The disclosure of U.S. patent application Ser. No. 15/234,263 is hereby incorporated, by reference, in its entirety.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for real-time management of risk exposure for an organization, comprising:
a server comprising at least one computer processor ingesting a plurality of messages from a plurality of source systems, each message relating to credit extended by an organization to one of a plurality of clients of the organization;
the server enriching each of the plurality of messages with reference data;
the server persisting the plurality of message in a database;
the server determining a credit risk exposure based on the persisted messages;
the server comparing the credit risk exposure to a risk threshold; and
the server reporting the credit risk exposure.

2. The method of claim 1, wherein the message is related to a transaction.

3. The method of claim 2, wherein the transaction comprises at least one of a security transaction, a settlement transaction, and a cash movement transaction.

4. The method of claim 1, wherein the plurality of source system comprise at least one of a Clearing Credit Checking system, an Automated Clearing House system, and an Account Monitoring and Payment Authorization system.

5. The method of claim 1, wherein the reference data comprises at least one of a domicile for the client, the client name, a client identifier, and parent information for the client.

6. The method of claim 1, further comprising:
the server encrypting the plurality of messages that are enriched with reference data before persisting the messages in the database.

7. The method of claim 1, further comprising:
the server aggregating the persisted messages with an updated message;
wherein the credit risk exposure is based on the aggregated messages.

8. The method of claim 1, wherein the credit risk threshold is based on a risk exposure policy.

9. The method of claim 1, further comprising:
the server executing a hold on an amount of funds in response to the credit risk exposure exceeding the credit risk threshold.

10. The method of claim 1, further comprising:
the server executing a hold on an account associated with the client.

11. A system for real-time management of risk exposure for an organization, comprising:
a server comprising at least one computer processor and an interface with a plurality of source systems;
at least one database; and
a dashboard;
wherein:
the server ingests a plurality of messages received at the interface from the plurality of source systems, each message relating to credit extended by an organization to one of a plurality of clients of the organization;
the server enriches each of the plurality of messages with reference data;
the server persists the plurality of message in the at least one database;
the server determines a credit risk exposure based on the persisted messages;
the server compares the credit risk exposure to a risk threshold; and
the server reports the credit risk exposure to the dashboard.

12. The system of claim 11, wherein the message is related to a transaction.

13. The system of claim 12, wherein the transaction comprises at least one of a security transaction, a settlement transaction, and a cash movement transaction.

14. The system of claim 11, wherein the plurality of source system comprise at least one of a Clearing Credit Checking system, an Automated Clearing House system, and an Account Monitoring and Payment Authorization system.

15. The system of claim 11, wherein the reference data comprises at least one of a domicile for the client, the client name, a client identifier, and parent information for the client.

16. The system of claim 11, wherein the server further encrypts the plurality of messages that are enriched with reference data before persisting the messages in the database.

17. The system of claim 11, wherein the server aggregates the persisted messages with an updated message, and the credit risk exposure is based on the aggregated messages.

18. The system of claim 11, wherein the credit risk threshold is based on a risk exposure policy.

19. The system of claim 11, wherein the server executes a hold on an amount of funds in response to the credit risk exposure exceeding the credit risk threshold.

20. The system of claim 11, wherein the server executes a hold on an account associated with the client.
